(19) United States
(12) Patent Application Publication
(10) Pub. No.: US 2025/0187240 A1
(43) Pub. Date: Jun. 12, 2025

(54) MOLD AND INJECTION MOLDING METHOD

(71) Applicant: TOYOTA JIDOSHA KABUSHIKI KAISHA, Toyota-shi (JP)

(72) Inventors: Atsushi SUGIHARA, Toyota-shi (JP); Shun KISHIMOTO, Toyota-shi (JP); Taichi ITO, Toyota-shi (JP); Fumio NOMIZO, Toyota-shi (JP); Yuki OKAMOTO, Kariya-shi (JP); Fumihiko ISHIGURO, Kariya-shi (JP); Takayuki HIROSE, Kariya-shi (JP); Masanori NISHIKI, Fukushima-shi (JP)

(73) Assignee: TOYOTA JIDOSHA KABUSHIKI KAISHA, Toyota-shi (JP)

(21) Appl. No.: 18/910,327

(22) Filed: Oct. 9, 2024

(30) Foreign Application Priority Data
Dec. 7, 2023 (JP) 2023-207112

(51) Int. Cl. B29C 45/26; B29C 45/14; B29L 31/34

(52) U.S. Cl. CPC B29C 45/2602; B29C 45/14065; B29K 2905/00; B29L 2031/3468

(57) ABSTRACT

To provide an injection molding die that can improve the productivity of the process of covering the side surface of the battery with resin.

A mold, comprising: a space capable of arranging a first end portion of a battery; and a fixing member capable of fixing the battery in a condition where the first end portion of the battery is arranged in a space; wherein the space is formed so that the second end portion of the battery jumps out of the space when the first end portion of the battery is arranged in the space; the fixing member has a fixed portion and a movable portion, the fixed portion is configured to support a first end surface of the battery; the movable portion is movable in a thickness direction; the second end surface of the battery can be pressed, and the fixing member can fix the battery by sandwiching the first end surface and the second end surface of the battery with the fixed portion and the movable portion; and the pressure applied to the battery from the movable portion is set to be equal to or less than a predetermined threshold value.

### FIELD

The present application relates to a mold and an injection molding method.

### BACKGROUND

Lithium ion battery, a portable power source such as a personal computer or a portable terminal, is widely used as a power source for a vehicle such as an electric vehicle or a hybrid vehicle. A lithium ion battery is composed of a positive electrode, a negative electrode, and an electrolyte layer, and a member which is deteriorated by intrusion of air, water, or the like from the outside is known among materials constituting these members. Therefore, in order to ensure water tightness and airtightness inside the battery, a technique is known in which the side surface of the battery is covered with a resin. Examples of a method of covering the battery side surface with a resin include a method using injection molding. For example, a mold for injection molding typical of Patent Document 1 is disclosed.

### CITATION LIST

### Patent Literature

Patent Literature 1: JP H10-15999 A

### SUMMARY

### Technical Problem

Incidentally, when covering the battery side surface with a resin in the injection molding, inserting the battery end into the cavity of the injection molding die, to fix the position of the battery. Then, by injecting the resin into the cavity, the battery side surface can be covered with the resin. However, there may be variations in the thickness of the battery due to manufacturing tolerances, there is a problem that can not be properly fixed to the battery in the cavity. Further, in the configuration of the conventional mold, there is a problem that must prepare a dedicated mold in accordance with the battery size. It is desired to solve these problems and to improve the productivity of a step of covering a battery side surface with a resin by injection molding.

In view of the above circumstances, it is a main object of the present disclosure to provide a mold and an injection molding method capable of improving productivity of a step of covering a battery side surface with a resin.

### Solution to Problem

The present disclosure provides at least the following aspects.

The first aspect is a mold for injection molding used to cover the side surface of the battery with a resin, a first end portion including a first side surface of the battery can be arranged in a space, and a fixed member capable of fixing the battery in a condition where the first end portion of the battery is arranged in the space, the space is formed so that the second end portion disposed on the opposite side of the first end portion of the battery when the first end portion of the battery is arranged in the space is protruding from the space, the fixed member has a fixed portion and a movable portion is configured to support the first end surface disposed in one of the thickness direction of the battery, the movable portion is movable in the thickness direction, the first end surface of the battery on the opposite side It is possible to press the disposed second end surface, the fixing member is possible to fix the battery by sandwiching the first end surface and the second end surface of the battery in the fixed portion, the pressure applied to the battery from the movable portion is set to be less than a predetermined threshold value, a mold.

The second aspect, the fixed member has a movable auxiliary portion for moving the movable portion in the thickness direction, the movable portion on the surface opposite to the battery side is a thickness direction, a first inclined portion inclined toward the direction perpendicular to the thickness direction has a movable auxiliary portion has a second inclined portion inclined along the first inclined portion, so as to contact the second inclined portion of the movable auxiliary portion along the first inclined portion of the movable auxiliary portion, by moving the movable auxiliary portion, moving the movable portion in the thickness direction, the mold according to the first embodiment.

The third aspect is an injection molding method for covering the side surface of the battery with a resin using the mold according to the first aspect or the second aspect, an arrangement step of placing the first end portion of the battery in the space of the mold, a fixing step of fixing the battery with a solid member in a condition where the first end portion of the battery is arranged in the space, and injection molding step of injecting a resin into the space, and covering the first end portion of the battery with a resin, in the fixing step, the pressure applied to the battery from the movable portion is set to be equal to or less than a predetermined threshold value, in the injection molding step, the amount of resin injected into the space is adjusted according to the position of the movable portion, an injection molding method.

### Advantageous Effects

According to the mold and the injection molding method of the present disclosure, it is possible to improve the productivity of the process of covering the battery side surface with the resin.

### BRIEF DESCRIPTION OF DRAWINGS

FIG. 1 It shows a schematic plan view when the battery 200 is installed in the mold 100.

FIG. 2 It is a schematic cross-sectional view cut in II-II of FIG.

FIG. 3 It is a schematic cross-sectional view of a condition of fixing the battery 200 by the fixing member 150.

FIG. 4 It is a schematic cross-sectional view of focusing on the first end 211 of the battery 200.

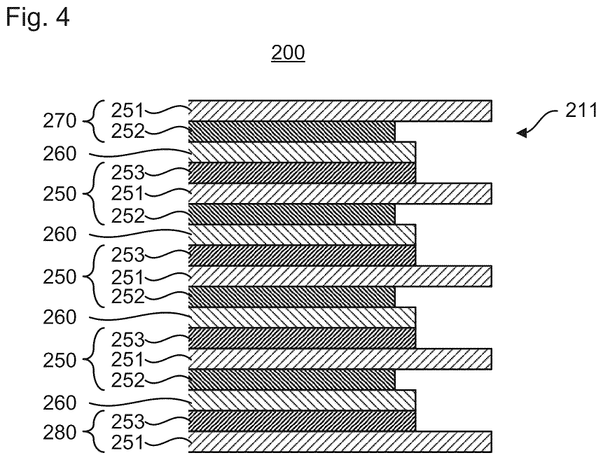

FIG. 5 It is a schematic cross-sectional view of focusing on the first end portion 211 of the battery 200 after injection molding.

FIG. 6 It is a flowchart of an injection molding method of an embodiment.

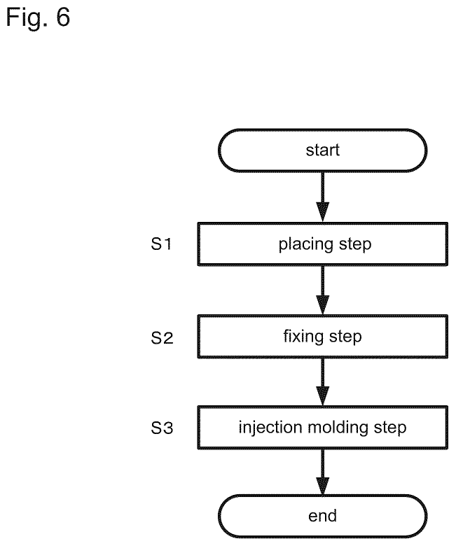

### DESCRIPTION OF EMBODIMENTS

### [Injection Molding Dies]

A mold of the present disclosure will be described using a mold 100 which is an embodiment.

The mold 100 is an injection molding mold used for covering a side surface of the battery 200 with a resin.

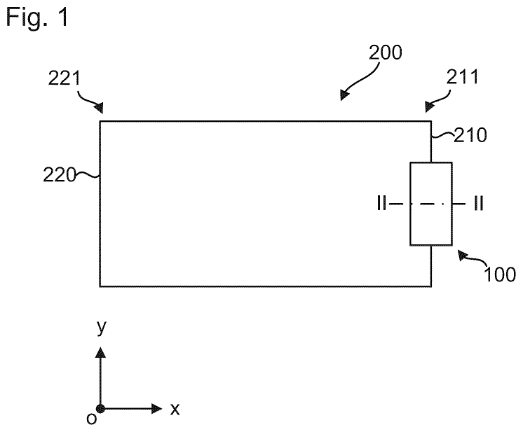

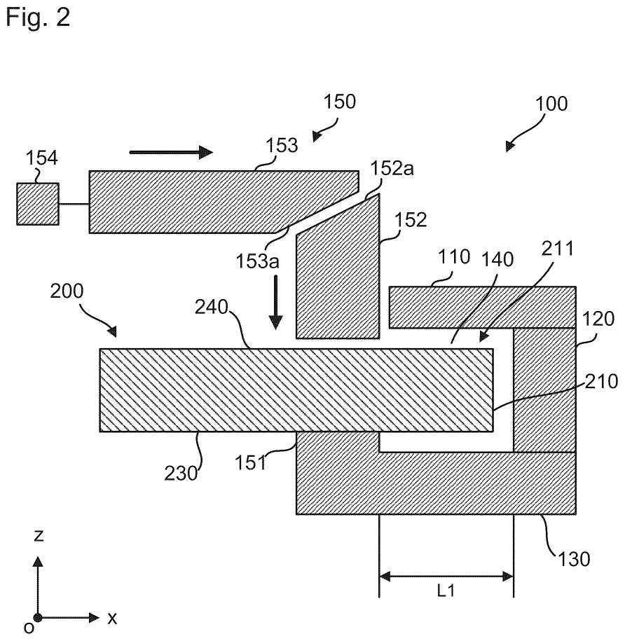

It shows a plan view when installed battery 200 in the mold 100 in FIG. 2 shows a cross-sectional view taken through II-II of FIG. Hereinafter will be described with reference to the direction shown in FIGS. 1 and 2. x direction is the longitudinal direction, y direction is the transverse direction, z direction is the thickness direction.

As shown in FIG. 1, the battery 200 has a rectangular shape in a thickness direction view, and has two end faces arranged in the thickness direction and four sides around. The mold 100 covers one side surface of the battery 200 with resin. Hereinafter, a side surface of a battery 200 intended to be covered with a resin by a mold 100 is referred to as a first side surface 210

### <Mold 100>

As shown in FIG. 2, the mold 100 has an upper mold 110, a horizontal mold 120, and a lower mold 130.

A space (cavity) 140 is formed through which a first end 211 including a first side surface 210 of a battery 200 can be placed by the member.

The upper mold 110 is a member disposed on an upper portion of the mold 100, and forms an upper surface of the space 140 The horizontal mold 120 is a member disposed between the upper mold 110 and the lower mold 130, and forms a side surface of the space 140 The lower mold 130 is a member disposed at a lower portion of the mold 100, and forms a lower surface of the space 140 Further, the outer side mold 130 has a shape extending longitudinally than the space 140, and has a fixing portion 151 for fixing the battery 200 outside the space 140. Note that the configuration of the mold 100 forming the space 140 is not limited to a form including the above-described upper mold 110, the horizontal mold 120, and the lower mold 130, and may be, for example, a form in which the horizontal mold 120 and the lower mold 130 are integrated and constitute one mold.

Fixing portion 151 is a convex portion projecting in the thickness direction. The fixing portion 151 also serves to stop the resin so that the resin does not leak from the space 140 during injection molding. Space 140 has a rectangular cross-section. Further, the space 140 has an opening on one side in the longitudinal direction (the left side of the paper surface in FIG. 2), the surface other than the opening is formed by the upper mold 110, the horizontal mold 120, the lower mold 130. Battery 200 is inserted into space 140 from the opening. Note that, although the space 140 shown in the drawing is exemplified by a rectangular cross sectional, the shape of the space 140 is not limited thereto, and may be in various forms, such as a circular cross section and an ellipse cross section, and may be appropriately set depending on the shape of the injection molding resin to be formed.

Space 140, a second end portion 221 (second side surface 220) (see FIG. 1) which is disposed on the opposite side of the first end portion 211 of the battery 200 when the first end portion 211 of the battery 200 is disposed in the space 140 It is formed so as to protrude from the space 140. This, in other words, means that only the first end 211 of the battery 200 is disposed in the space 140. Thus, unlike the general injection molding die, it is possible to perform injection molding with respect to the first end portion 211 of the battery 200 in a small mold.

In addition, it is sufficient that at least a portion of the first end portion 211 is disposed in the space 140 FIG. 1 illustrates a configuration in which a portion of the first end 211 of the battery 200 can be placed in the space 140. However, the mold 200 may be configured such that the entire first end 211 of the battery 200 can be disposed in the space 140.

The size of the space 140 is set according to the range in which the first end portion 211 is covered with the resin. For example, the longitudinal length L1 of the space 140 is preferably below 0 mm super 100 mm, more preferably above 3 mm and below 50 mm, and still more preferably above 5 mm and below 30 mm (FIG. 2) The length of the space 140 in the thickness direction is set according to the size of the battery 200. The length of the space 140 in the short direction may be set according to the purpose. For example, when a portion of the side surface 210 (first end portion 211) of the battery 200 is covered with a resin as in FIG. 1, the length of the space 140 in the short side direction may be shorter than the length of the battery 200 in the short side direction. When the entire side surface 210 (first end portion 211) of the battery 200 is covered with resin, the length of the space 140 in the short direction may be longer than the length of the battery 200 in the short direction.

The mold 100 includes a securing member 150 capable of securing the battery 200 with the first end 211 of the battery 200 condition in the space 140 for proper injection molding. Fixing member 150 has a fixed portion 151, movable portion 152, movable auxiliary portion 153, and a control unit 154.

Fixing portion 151 is a convex portion provided in the lower mold 130 described above, and is configured to support the first end face 230 disposed on one of the thickness direction of the battery 200. Movable portion 152 has a floating structure, is movable in the thickness direction, it is possible to press the second end surface 240 disposed on the opposite side of the first end face 230 of the battery 200. Further, the movable portion 152 is a thickness direction, the surface opposite to the battery 200 side, has a first inclined portion 152a which is inclined toward the direction perpendicular to the thickness direction (longitudinal direction in FIG. 2). Movable auxiliary portion 153 has a second inclined portion 153a which is inclined along the first inclined portion 152a, movable in a direction (longitudinal direction in FIG. 2) perpendicular to the thickness direction. Control unit 154 is a member for controlling the movement of the movable auxiliary unit 153. The control unit 154 may be used, for example, a servo cylinder.

It will be described a mechanism for fixing the battery 200 with the fixing member 150. As shown in FIG. 2, first moving the movable auxiliary portion 153 in the longitudinal direction of the first end portion 211 side (the right side of the paper surface in FIG. 2), is brought into contact with the movable portion 152. Specifically, by operating the control unit 154, the second inclined portion 153a of the movable auxiliary unit 153 is brought into contact with the first inclined portion 152a of the movable portion 152. Then, by moving the movable auxiliary unit 153 further longitudinal first end 211 side, the second inclined portion 153a pushes the one inclined portion 152b in the thickness direction, the movable portion 152 is moved to the battery 200 side in the thickness direction. Then, the movable portion 152 presses the second end face 240 of the battery 200. Since the first end face 230 of the battery 200 is supported by the fixed portion 151, the battery 200 is fixed is sandwiched between the fixed portion 151 and the movable portion 152.

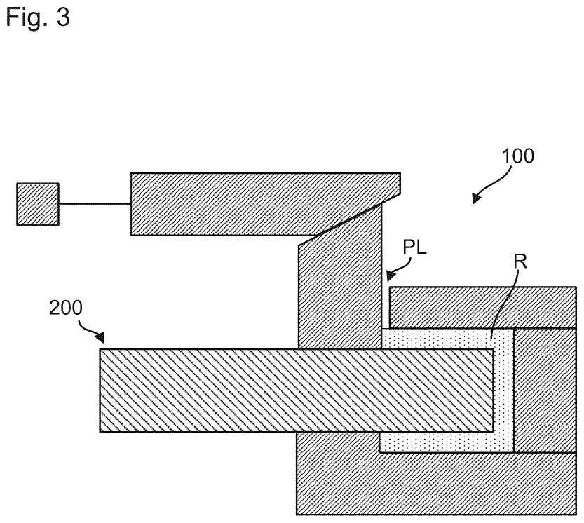

Corresponds to FIG. 2 in FIG. 3 shows a schematic cross-sectional view of a mold 100 in a condition of fixing the battery 200 by the fixing member 150. As shown in FIG. 3, when the battery 200 is fixed by the fixing member 150, the parting surface (PL of FIG. 3) is formed between the side surface of the movable portion 152 and the side surface of the upper mold.

Thus, the fixing member 150, the second inclined portion 153a of the movable auxiliary portion 153 so as to contact along the first inclined portion 152a of the movable portion 152, by moving the movable auxiliary portion 153 in the longitudinal direction, the movable portion 152 it can be moved in the thickness direction. Then, the fixing member 150 can fix the battery 200 by sandwiching the first end face 230 and the second end face 240 of the battery 200 in the fixed portion 151 and the movable portion 152.

Here, the fixing member 150, the pressure applied to the battery 200 from the movable portion 152 is set to be equal to or less than a predetermined threshold value. Thus, it is possible to appropriately fix the battery 200 having relatively low strength. Further, even when variations in the thickness of the battery 200 occurs due to manufacturing tolerances, the movable portion 152 follows the thickness of the battery, it is possible to fix the battery 200 at an appropriate pressure while suppressing damage to the battery 200. And suppression of burrs by stably fixing the battery 200, it is possible to suppress the deviation due to injection pressure. The predetermined threshold value, depending on the strength of the battery 200 or the like, may be set to a pressure that does not damage the battery 200.

The mold 100 injects the resin R into the space 140 in a condition in which the battery 200 is fixed, and covers the first end portion 211 including the first side surface 211 of the battery 200 with the resin R Here, the amount of resin injected into the space 140 may be adjusted according to the position of the movable portion 152 (that is, the thickness of the battery 200) Alternatively, by estimating the thickness of the battery 200 from the stop position of the control unit 154, it may set the amount of resin. Thus, an appropriate amount of resin can be injected into the space 140

Note that, in one embodiment, a mold 200 is shown in which the first end 211 including the first side surface 210 disposed in the longitudinal direction of the battery 200 is covered with a resin, but the mold 200 is not limited to this form. The mold 200 can cover either end of the battery 200 with resin. For example, an end portion including a side surface disposed in a short direction of the battery 200 may be covered with a resin.

Further, the mold 100 may be provided with a member other than the above-described member. For example, a member or the like for injecting a resin into the space 140 may be provided.

### <Battery 200>

As described above, the battery 200 has a rectangular shape in the thickness direction view. The type of the battery 200 is not particularly limited. The battery 200 may be a liquid-based battery or a solid-state battery. Battery 200 may be monopolar or bipolar. The battery 200 may be a lithium ion battery or a sodium ion battery. A resin may be disposed on a side surface of the battery 200 The following describes the case where the battery 200 has the configuration of a typical bipolar-type lithium-ion battery. However, the battery 200 is not limited to this form.

It shows a schematic cross-sectional view of the first end portion 211 of the battery 200 in FIG. Battery 200 includes a plurality of bipolar electrodes 250 and a plurality of electrolyte layers 260, with alternating layers of bipolar electrodes 250 and electrolyte layers 260. The number of the bipolar electrode 250 and the electrolyte layer 260 is not particularly limited, and may be appropriately set according to the target battery performance. The battery 200 further includes an end portion positive electrode 270 disposed at one end of the stacking direction, and an end portion negative electrode 280 disposed at the other end of the stacking direction.

The bipolar electrode 250 includes a current collector 251, a positive electrode layer 252 disposed on one surface of the current collector 251, and a negative electrode layer 253 disposed on the other surface of the current collector 251 Thus, the bipolar electrode 250 includes electrode layers of different poles on both surfaces of the current collector 251

Current collector 251 is a sheet-like conductive member. Examples of the current collector 251 include metal foils such as stainless steel, iron, copper, aluminum, titanium, and nickel. The metal foil may be made of an alloy containing 2 or more of these metals. Further, the metal foil may be subjected to a surface treatment such as a predetermined plating. The current collector 251 may be made of a plurality of metal foils. In this case, the metal foil may be bonded by an adhesive or the like, and may be bonded by a press or the like. The shape of the current collector 251 may be rectangular. The thickness of the current collector 251 is not particularly limited, but is, for example, 5 μm or more and 70 μm or less.

The positive electrode layer 252 includes a positive electrode active material. The positive electrode active material is not particularly limited and may be appropriately selected from known materials according to the target battery performance. Examples thereof include composite oxides, metallic lithium, and sulfur. Compositions of the composite oxide include, for example, at least one of iron, manganese, titanium, nickel, cobalt, and aluminum, and lithium. Exemplary complex oxides include olivine-type lithium-iron phosphate (LiFePO₄) and the like.

Positive electrode layer 252 may optionally include a conductive aid. The conductive auxiliary agent is not particularly limited and may be appropriately selected from known materials according to the target battery performance. Examples thereof include carbon materials such as acetylene black, carbon black, and graphite.

The positive electrode layer 252 may optionally contain a binder. The binder is not particularly limited and may be appropriately selected from known materials according to the target battery performance. Examples thereof include fluorine contain resins such as polyvinylidene fluoride, polytetrafluoroethylene, and fluorine rubber; thermoplastic resins such as polypropylene and polyethylene; imide-based resins such as polyimide and polyamideimide; acrylic resins such as alkoxysilyl group-containing resins and poly (meth) acrylic acid; styrene-butadiene rubber (SBR); carboxy methylcellulose; alginates such as sodium alginate and ammonium alginate; water-soluble cellulose ester crosslinked bodies; starch-acrylic acid graft polymers; and the like.

The positive electrode layer 252 may have a rectangular shape. The thickness of the positive electrode layer 252 is not particularly limited, and is, for example, within a range of 1 μm to 1 mm The area of the positive electrode layer 252 may be smaller than that of the negative electrode layer 253 The content of each material in the positive electrode layer 252 is not particularly limited, and may be appropriately set according to the target battery performance. Note that the positive electrode layer 20 may include a material other than the material described above.

The negative electrode layer 253 includes a negative electrode active material. The negative electrode active material is not particularly limited and may be appropriately selected from known materials according to the target battery performance. Examples thereof include carbon such as graphite, artificial graphite, highly oriented graphite, mesocarbon microbeads, hard carbon, and soft carbon, a metal compound, an element or a compound thereof which can be alloyed with lithium, and boron-added carbon. Examples of elements alloyable with lithium include silicon and tin.

The negative electrode layer 253 may optionally include a conductive aid. The conductive auxiliary agent is not particularly limited and may be appropriately selected from known materials according to the target battery performance. For example, it may be appropriately selected from conductive auxiliaries applicable to the positive electrode layer 252

The negative electrode layer 253 may optionally contain a binder. The binder is not particularly limited and may be appropriately selected from known materials according to the target battery performance. For example, it may be appropriately selected from the binder applicable to the positive electrode layer 252

The negative electrode layer 253 may have a rectangular shape. The thickness of the negative electrode layer 253 is not particularly limited, and is, for example, within a range of 1 μm to 1 mm The area of the negative electrode layer 253 may be larger than that of the positive electrode layer 252 from the viewpoint of improving output. The content of each material in the negative electrode layer 253 is not particularly limited, and may be appropriately set according to the target battery performance. Note that the negative electrode layer 253 may include a material other than the material described above.

A method of manufacturing the bipolar electrode 250 is not particularly limited, and a known method may be employed. For example, for example, a material constituting an electrode layer (positive electrode layer 252 or negative electrode layer 253) may be mixed in a mortar or the like and pressed to obtain an electrode layer, and the obtained electrode layer may be disposed on each surface of the current collector 251 Alternatively, after the material constituting the electrode layer is mixed with a solvent to obtain a slurry, the slurry may be applied and dried on the respective surfaces of the current collector 251

An electrolyte layer 260 is disposed between adjacent bipolar electrodes 250, between bipolar electrodes 250 and end positive electrodes 270, and between bipolar electrodes 250 and end negative electrodes 280.

When the electrolyte layer 260 is a liquid-based electrolyte layer, a separator is disposed between the electrodes, and then an electrolyte solution is supplied to the separator to obtain an electrolyte layer. Separators are mainly polyolefin-based porous sheets. The electrolytic solution is obtained by dissolving a supporting salt in a nonaqueous solvent. Examples of the nonaqueous solvent include carbonates, Ether, and esters. Examples of the support salt include LiPF₆, LiBF₄, lithium bis (fluorosulfonyl) imide (LiFSI), lithium bis (trifluoromethane) sulfonimide (LiTFSI), and the like.

When the electrolyte layer is a solid electrolyte layer, a battery can be manufactured by disposing a solid electrolyte layer between electrodes. The solid electrolyte layer includes a solid electrolyte. Further, the solid electrolyte layer may contain a binder. The solid electrolyte and the binder may be appropriately selected from the solid electrolyte and the binder described above.

The electrolyte layer 260 may have a rectangular shape. The thickness of the electrolyte layers 260 is not particularly limited, and ranges from 1 μm to 1 mm, for example.

The end negative electrode 270 has a current collector 251 and a positive electrode layer 252 disposed on one surface of the current collector 251 End negative electrode 270 is disposed at one end of the stacking direction of the electrode stack 18. Specifically, the end negative electrode 270 is laminated on the electrolyte layer 260 so that the positive electrode layer 252 of the end negative electrode 270 and the negative electrode layer 253 of the bipolar electrode 250 face each other.

The end negative electrode 280 has a current collector 251 and a negative electrode layer 253 disposed on one surface of the current collector 251 End negative electrode 280 is disposed at the other end of the stacking direction of the electrode stack 18. Specifically, the end negative electrode 280 is laminated on the electrolyte layer 260 so that the negative electrode layer 253 of the end negative electrode 280 and the positive electrode layer 252 of the bipolar electrode 250 face each other.

A method of manufacturing the end negative electrode 270 and the end negative electrode 280 is not particularly limited, and a known method may be appropriately employed. For example, a method similar to the method of manufacturing the bipolar electrode 250 described above may be employed.

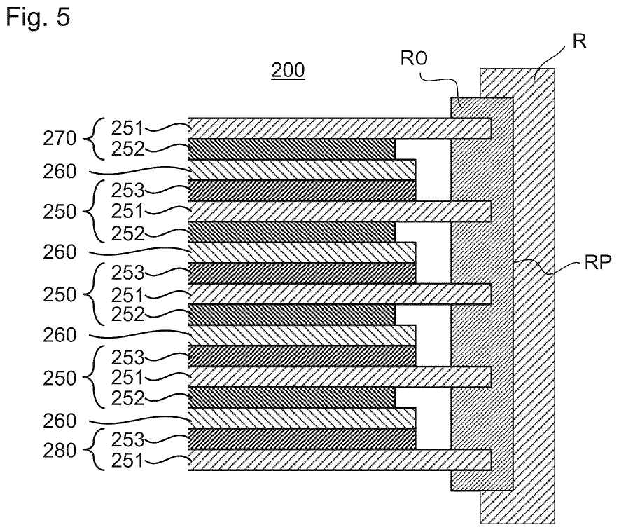

It shows a schematic cross-sectional view focusing on the first end portion 211 of the battery 200 after injection molding in FIG. As shown in FIG. 5, resin R is disposed at a first end 211 that includes a first side surface 210 of a battery 200 by injection molding.

Specifically, one example of the use of the disclosed mold is a method in which, for example, four pieces including the first side surface 210 of the battery 200 shown in FIG. 1 are additionally covered with the resin R with respect to a part of the battery covered with the resin R0 in advance (for example, with respect to a part of the first side surface 210 covered with the resin R0), and FIG. 5 is a schematic cross-sectional view of the battery 200 after injection molding produced by such a method. Therefore, the resin R is formed so as to cover the end face RP of the resin R0

Further, the resin R0 is disposed so as to enter between the neighboring bipolar electrodes 250 (current collector 251), and covers the first side surface 210 with the resin. The resinous R0 is also disposed at the end of the respective end faces of the battery 200 (first end face 230 and second end face 240). Further, it is spaced apart from the electrode layer (the positive electrode layer 252 and the negative electrode layer 253) Thus, the first end portion 211 of the battery 200 is covered with the resin R0, and further, the end surface RP of the resin R0 is covered with the resin R

From the above, a mold for injection molding of the present disclosure has been described using an embodiment. According to the mold for injection molding of the present disclosure, since the variation in the thickness of the battery due to the manufacturing tolerance can be absorbed, it is possible to reduce the degree of difficulty in the process of covering the battery side surface with the resin by injection molding, and thus it is possible to improve the productivity.

### [Injection Molding Method]

The injection molding method of the present disclosure is a method of covering a side surface of a battery with a resin using a mold of the present disclosure.

An injection molding method of the present disclosure will be described using an embodiment.

One embodiment is an injection molding method for covering an end of a battery 200 with a resin using a mold 100 One embodiment includes a placement process S1, a fixation process S2, and an injection molding process S3. It shows a flowchart of an injection molding method of an embodiment in FIG.

### <Arrangement Process S1>

The placing step S1 is a step of placing the first end 211 of the battery 200 in the space 140 of the mold 100. At this time, to support the first end face of the battery 200 in the fixing portion 151.

### <Fixing Process S2>

The fixing step S2 is a step of fixing the battery 200 with the solid-state member 150 while the first end 211 of the battery 200 is disposed in the space 140. More specifically described above, the fixing step S2, the second inclined portion 153a of the movable auxiliary portion 153 so as to contact along the first inclined portion 152a of the movable portion 152, by moving the movable auxiliary portion 153 in the longitudinal direction, the movable portion 152 It is moved in the thickness direction. Then, the fixing member 150 sandwiches the first end face 230 and the second end face 240 of the battery 200 with the fixed portion 151 and the movable portion 152. Thus, fixing the battery 200 with the fixing member 150.

Here, in the fixing step S2, the pressure applied from the movable portion 152 to the battery 200 may be set to be equal to or less than a predetermined threshold. Thus, even when variations in the thickness of the battery 200 caused by manufacturing tolerances, it is possible to fix the battery at an appropriate pressure while suppressing damage to the battery 200.

### <Injection Molding Process S3>

Injection molding step S3 injects a resin R into the space 140, the first end portion 211 of the battery (if the first end 211 is previously covered with a resin R0, the end face RP of the resin R0) a step of covering with a resin R. In the injection molding process, the amount of resin injected into the space 140 may be adjusted according to the position of the movable portion 152 By adjusting the amount of resin to be supplied to the space 140 according to the position of the movable portion 152, the first end portion 211 can be appropriately covered with the resin R even when variations occur in the thickness of the battery 200

By carrying out the process S1 to process S3, one end of the battery 200 can be resin-covered. Further, by performing the process S1 to process S3 for each end of the battery, it is possible to cover each end of the battery 200 with resin.

As described above, an injection molding method of the present disclosure has been described using an embodiment. According to the injection molding method of the present disclosure, since the variation in the thickness of the battery due to the manufacturing tolerance can be absorbed, it is possible to reduce the degree of difficulty in the step of covering the battery side surface with the resin by the injection molding, and thus it is possible to improve the productivity.

### REFERENCE SIGNS LIST

100, 101, 102 Mold
110 Upper mold
120 Horizontal type
130 Lower mold
140 Space
150 Fixing member
151 Fixation part (convex part)
152 Moving part
152a 1st slope
153 Mobile auxiliary section
153a second inclined portion
154 Control unit
200 Battery
210 Side 1
211 First end
220 Second side surface
221 Secondary end
230 First end face
240 Second end face
250 Bipolar electrode
251 Collector
252 Positive electrode layer
253 Negative electrode layer
260 Separator
270 End positive
280 End negative
R Resin

What is claimed is:

1. A metal mold for injection molding, the metal mold being used for covering a side face of a battery with resin, the metal mold comprising:
a space in which a first end portion of the battery can be placed, the first end portion including a first side face of the battery; and
a fixing member with which the battery can be fixed in a state where the first end portion is placed in the space, wherein
the space is formed so that a second end portion of the battery protrudes from the space when the first end portion is placed in the space, the second end portion being arranged on an opposite side of the first end portion,
the fixing member has a fixed part and a movable part,
the fixed part is configured to support a first end face of the battery, the first end face being arranged on one side in a thickness direction of the battery,
the movable part can be moved in the thickness direction, and can press against a second end face of the battery, the second end face being arranged on an opposite side of the first end face,
the battery can be fixed with the fixing member by sandwiching the first end face and the second end face between the fixed part and the movable part, and
a pressure to be applied to the battery from the movable part is set to be at most a predetermined threshold value.

2. The metal mold according to claim 1, wherein
the fixing member has a movable auxiliary part for moving the movable part in the thickness direction,
the movable part has a first inclined portion inclining toward a direction orthogonal to the thickness direction on a face thereof on an opposite side of the battery in the thickness direction,
the movable auxiliary part has a second inclined portion inclining along the first inclined portion, and
the movable part is moved in the thickness direction by moving the movable auxiliary part, so that the second inclined portion comes into contact with the first inclined portion along the first inclined portion.

3. An injection molding method for covering a side face of a battery with resin by using the metal mold according to claim 1, the method comprising:
placing the first end portion in the space;
fixing the battery with the fixing member in the state where the first end portion is placed in the space; and
injecting the resin into the space to cover the first end portion with the resin, wherein
in said fixing, the pressure applied to the battery from the movable part is set to be at most the predetermined threshold value, and
in said injection molding, an amount of the resin injected into the space is adjusted according to a position of the movable part.
